(19) United States
(12) Patent Application Publication
(10) Pub. No.: US 2008/0045426 A1
(43) Pub. Date: Feb. 21, 2008

(54) Dryer-added fabric care articles imparting malodor absorption benefits

(76) Inventor: George Kavin Morgan, Hamilton, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/506,064

(22) Filed: Aug. 17, 2006

(51) Int. Cl. C11D 3/50; C11D 3/00

(52) U.S. Cl. 510/101; 510/520

(57) ABSTRACT

Dryer-added fabric conditioning articles comprising a reactive aldehyde moiety treat or prevent malodor on fabric.

### FIELD OF INVENTION

The present invention relates to dryer-added articles that comprise perfumes that comprise aldehyde moieties.

### BACKGROUND OF THE INVENTION

There is a need to refresh clothing—opposed to laundering clothing after clothing has become soiled. Laundering clothing often has the perception of being labor intensive or a process that subjects clothing to harsh conditions. Refreshing clothing is generally thought of as a process that is fast, easy, and gentle on clothing.

Moreover, there is also a need to extend the time period between laundering or refreshing clothing, i.e., to prevent malodor on clothing. There is yet also a need to provide one or more of these needs in a time and cost effective manner.

### SUMMARY OF THE INVENTION

The present invention attempts to addresses this and other needs by providing, in a first aspect of the invention, of a dryer-added article that comprises a free perfume, wherein the free perfume comprises at least 10 mg, preferably at least 20 mg of a perfume ingredients that comprises a free reactive aldehyde moiety.

Another aspect of the invention provides of the treatment of malodor on fabric comprising the step of administering an article of the present invention into an automatic clothing dryer.

Yet another aspect of the invention provides for the prevention of malodor on fabric comprising the step of administering an article of the present invention into an automatic clothing dryer.

Kits for using the articles of the present invention are also provided.

### BRIEF DESCRIPTION OF THE DRAWING

FIG. 1 is directed to a bar graph comparing the initial effect of a dryer sheet of the present invention to that of a commercially sold dryer sheet, in the prevention of malodor on fabric, wherein the fabric is impregnated with cigarette smoke.

FIG. 2 is directed to a bar graph comparing the effect after one week of a dryer sheet of the present invention to that of a commercially sold dryer sheet, in the prevention of malodor on fabric, wherein the fabric is impregnated with cigarette smoke.

FIG. 3 is directed to a bar graph comparing the initial effect of a dryer sheet of the present invention to that of a commercially sold dryer sheet, in the prevention of malodor on fabric, wherein the fabric is impregnated with artificial body odor.

FIG. 4 is directed to a bar graph comparing the effect after one week of a dryer sheet of the present invention to that of a commercially sold dryer sheet, in the prevention of malodor on fabric, wherein the fabric is impregnated with artificial body odor.

FIG. 5 is directed to a bar graph comparing the initial effect of a dryer sheet of the present invention to that of a commercially sold dryer sheet, in the treatment of malodor on fabric, wherein the fabric is impregnated with cigarette smoke.

FIG. 6 is directed to a bar graph comparing the effect after one week of a dryer sheet of the present invention to that of a commercially sold dryer sheet, in the treatment of malodor on fabric, wherein the fabric is impregnated with cigarette smoke.

FIG. 7 is directed to a bar graph comparing the initial effect of a dryer sheet of the present invention to that of a commercially sold dryer sheet, in the treatment of malodor on fabric, wherein the fabric is impregnated with artificial body odor.

FIG. 8 is directed to a bar graph comparing the effect after one week of a dryer sheet of the present invention to that of a commercially sold dryer sheet, in the treatment of malodor on fabric, wherein the fabric is impregnated with artificial body odor.

### DETAILED DESCRIPTION OF THE INVENTION

Perfume Composition

One aspect of the invention provides a dryer-added article that comprises at least about 9 mgs, alternatively at least about 10 mg, or 11, 12, 13, 14, 15, 16, 17, 18, 19, 20, 21, 22, 23, 24, or at least about 25 of a free perfume ingredient comprising a reactive aldehyde functionality. In one embodiment, the article comprises less than 100 mg, alternatively less than 50 mg of perfume ingredient(s) comprising a reactive aldehyde functionality. For purposes of the present invention the term “perfume ingredient comprising a reactive aldehyde functionality” means any perfume ingredient that comprises at least one reactive aldehyde moiety (—CHO) in its molecular structure. Without wishing to be bound by theory, it is believed that a perfume ingredient comprising a reactive aldehyde functionality may chemically bind to the malodor molecule thereby rendering the malodor molecule unavailable to the headspace above the clothing and thus rendering unavailable for scent detection by the user.

“Malodor” means an undesirable odor, such as, but not limited to, smoke or body odor, or a combination thereof.

“Free perfume ingredient” means, for purposes of the present invention, a compound that imparts a desirable odor to treated fabric as understood by one skilled in the perfume arts and that is neither absorbed onto or into a perfume carrier (e.g., absorbed on to zeolites or clays or cyclodextrins) nor encapsulated (e.g., in a perfume microcapsule).

A “pro-perfume” is included within the present definition of a “perfume ingredient.” The term “pro-perfume” is generally described at US 2005/0192204 A1, ¶5 et seq., and the references cited therein. An example of a pro-perfume is a Cliff-base, see e.g., U.S. Pat. Publ. Nos. 2005/0239667 A1; 2005/0043208 A1; 2004/0106528 A1; 2003/0153474 A1; 2003/0064899 A1.

The terms “prevent malodor” and “treat malodor” are used herein the broadest sense. The term “prevent” may include the prevention, repulsion, shielding, mitigation, or combinations thereof. For purposes of clarification, the term “prevent” does not necessarily mean that no malodor is on the clothing, rather that there is less malodor on the clothing in a given unit area on clothing after the clothing is dried in an automatic clothing dryer with an article of the present invention and thereafter being exposed to malodor as compared to an article that is dried with a reference article. The term “treatment” may include the treatment, removal, elimination, re-freshing, rejuvenation, revive, restore, or combination thereof. For purposes of clarification, the term “treatment” means that there is less malodor on clothing that has malodor in given unit area on clothing after the clothing is dried in an automatic clothing dryer with an article of the present invention as compared to an article that is dried with a reference article. In one embodiment, the term “prevent” or “treatment” means there is about less than 95%, alternatively less than about any one of the following percentages: 90%, 85%, 80%, 70%, 60%, 50%, 40%, 30%, 20%, 10%, or 5%; of the malodor in the headspace coming off of the fabric. over the total area of the fabric, or alternatively, over any given area or total area of fabric treated with an article of the present invention, as compared to fabric that was not treated with an article of the present invention. In one embodiment, the given area is about 20 cm×20 cm.

In the perfume arts, it is appreciated that some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., diluting and stabilizing some perfume ingredients. For purposes of this invention, these materials are neither included within the definition of “perfume ingredient” nor “free perfume ingredient,” and thus are specifically excluded as part of the term “free perfume composition.”

In one embodiment, the perfume composition may comprises at least about 3 different perfume ingredients that comprise a reactive aldehyde moiety, alternatively at least 4, or 5, or 6, or 7, or 8, or 9, or 10, or more, different reactive aldehyde functionality comprising perfume ingredients.

In one embodiment, the perfume ingredient comprising a reactive aldehyde functionality is chosen from at least one of the following: 2-Methyl-2-Butenal; 2-Nonenal (Iris Aldehyde); 2-Tridecenal, 2-Undecenal; 3,5,5-Trimethyl Hexanal; 3; Methyl-2-Butenal; 3-Methylthio Propanal; 5-Methyl Furfural; 6-Nonenal; 9-Decenal; alpha-Methyl; Cinnamic Aldehyde; alpha-Pinyl iso-Butyraldehyde; Amyl Cinnamic Aldehyde; Anisic Aldehyde; Benzaldehyde; Bergamal; Bourgenal; Butyl Cinnamic Aldehyde; Campal (IFF); Cinnamic Aldehyde; cis-2-Hexenal; cis-3-Hexenal; cis-4-Decenal; Citronellal; Citronellyl OxyAcetaldehyde; Cumin Aldehyde; Cyclotropal; cymal; Decyl Aldehyde; Ethoxy Citronellal; Florhydral; Folial; Furfural; Geraldehyde; Geranial; Geranoxyl Acetaldehyde; Glutaraldehyde; Helional; Heptanal; Hexanal; hexyl cinnamic aldehyde; Hydratropic Aldehyde; Hydroxycitronellal; Inonanal (PPF); iso-Cyclamal; iso-Cyclo Citral; Lauric Aldehyde; Ligustral (“Cyclal C”); Lilial; Lirninal; Lyral; Mefranal; Melonal; (2,6-DiMethyl-2-Heptenal); Methoxy Citronellal; Methyl Nonyl Acetaldehde; Methyl Octyl Acetaldehyde; Methyl Salicylaldehyde; m-Hydroxy Benzaldehyde; Myrtenal; Neral; Neraldehyde; Nonanal; Octanal; Perilla Aldehyde; Phenyl Acetaldehyde; Phenylpropanal; p-Hydroxy Benzaldehyde; Safranal; Salicylaldehyde; Sinensal; trans-2,4-Decadienal; trans-2-cis-6-Nonadienal; trans-2-Hexenal; trans-2-Pentenal; trans-4-Decenal; Trifernal; Undecenal, Undecyl Aldehyde; Veratraldehyde, Verdural; Vernaldehyde; Vetival; or combinations thereof.

Testing

The effect of a dryer sheet comprising a free perfume ingredient comprising a reactive aldehyde functionality is evaluated. Two methods of testing are used to simulate the “prevention” and “treatment” of malodors on fabric. The specific malodors tested are smoke and body odor since these malodors are identified as key problematic malodors for consumers on their clothing.

Washing and treatment conditions. Washing conditions provide 20.3 cm×20.3 cm of 60% cotton/40% polyester blend polycotton swatches that are washed (using TIDE Free detergent with ballast (3 cotton terry towels and 3 cotton tee shirts) to simulate the average U.S. washing laundry load). Drying conditions provide drying in an automatic clothing dryer under “high heat” for 20 minutes using a MAYTAG Commerial dryer (model: MLE23MNFYW) with or without a dryer sheet (the dryer sheet being either an embodiment of the present invention or a reference dryer sheet).

The methodology for how test swatches are exposed to a malodor is provided:

Smoke malodor impregnation method. The swatches are hung on a carousel in a 30 gallon trash can. A lit cigarette is inserted into the bottom of the can and held inside for 10 seconds. After 10 seconds, the cigarette is removed and the hole taped up. The swatches remain in the can for 2 minutes while the carousel is rotated. Thereafter, the swatches remain in the can for yet another 15 minutes, at which point they are removed and ready for testing.

ABO malodor impregnation method: Artificial Body Odor (ABO) is sprayed four times onto the swatches. The swatches are air dried for 2 hours and then ready for testing.

Malodor prevention and treatment methodologies are provided:

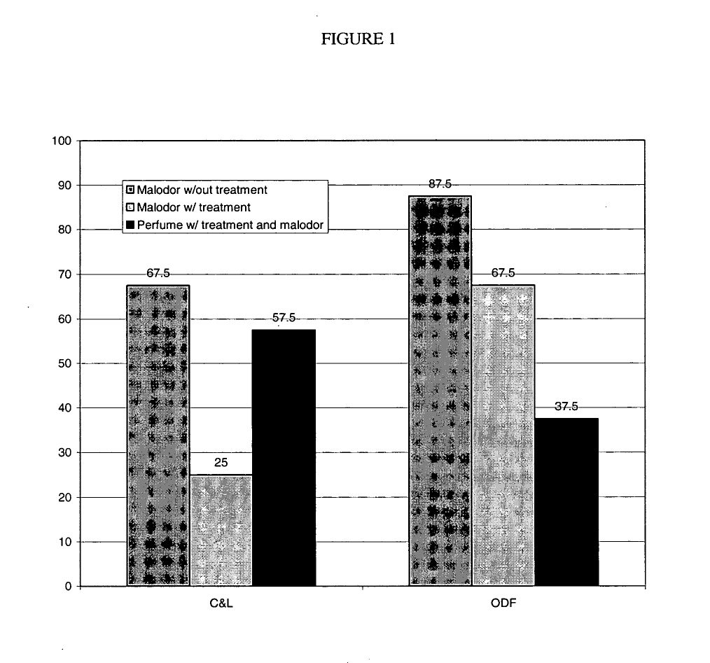

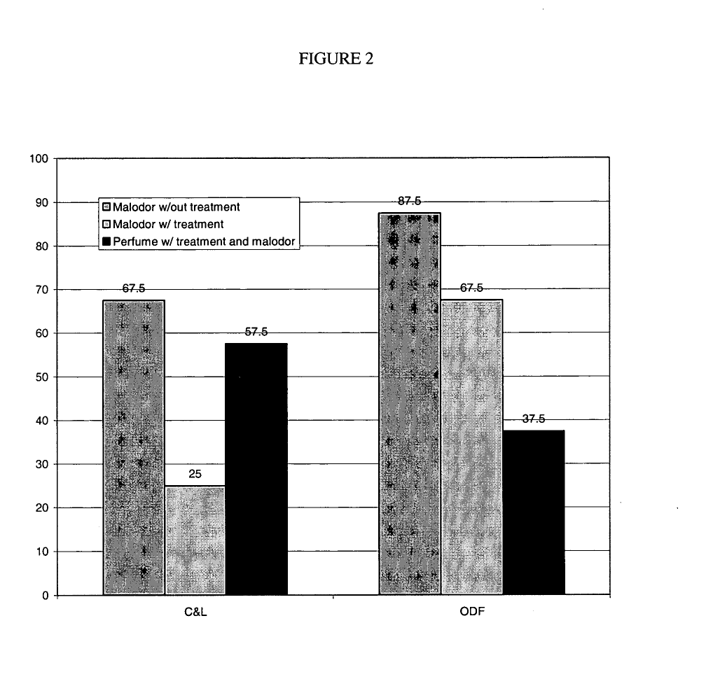

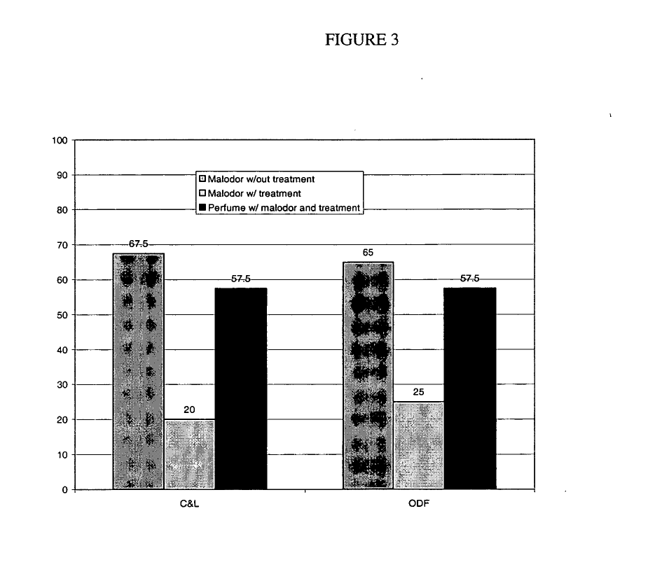

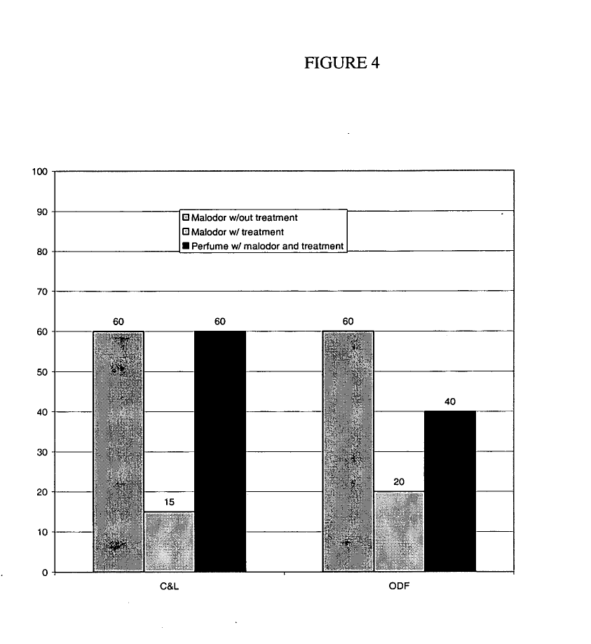

Under malodor prevention conditions, the swatches are first washed (as previously described) and dried (as previously described) with and without a dryer sheet treatment. Thereafter, the swatches are exposed to malodor and evaluated by an expert perfumer(s). Treatment with a dryer sheet includes the use of a dryer sheet of the present invention (so called “Citrus and Light” or “CL”) and a reference dryer sheet that is the currently sold version of the most popular brand and variety of dryer sheet in the U.S. market at the time of this application (so called BOUNCE Outdoor Fresh or “ODF”). The “Citrus and Light” dyer sheet comprises about 20 mg of perfume ingredients that comprises a free reactive aldehyde moiety whereas the BOUNCE Outdoor Fresh dryer sheet comprises approximately 9 mg of perfume ingredients that comprises an free aldehyde moiety. The results are reported herein as FIGS. 1 through 4.

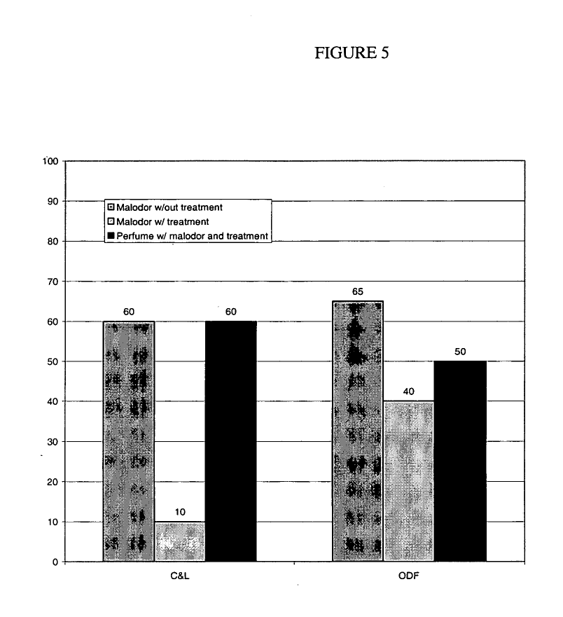

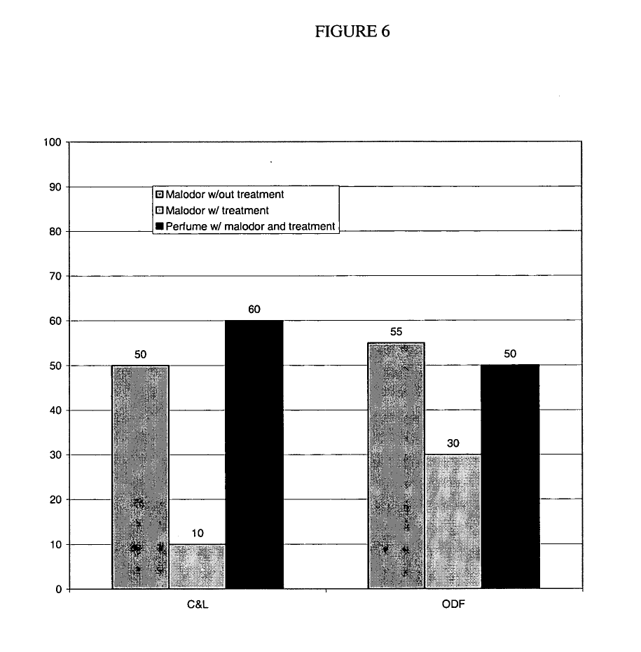

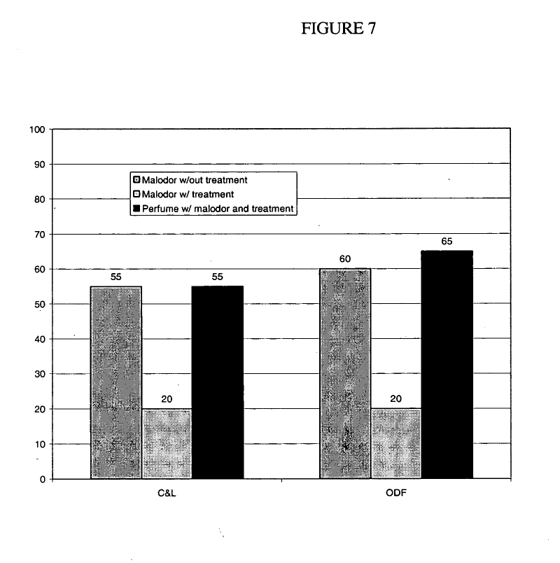

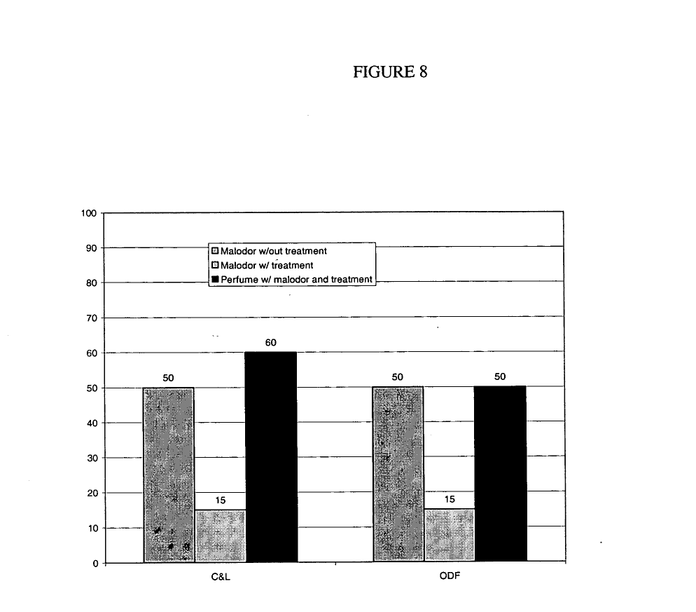

Under malodor treatment conditions, the swatches are first washed (as previously described) and dried (as previously described) without a dryer sheet treatment. Thereafter, the swatches are exposed to malodor. Then the swatches are dried yet again with and without a dryer sheet treatment. Lastly, the swatches are evaluated by an expert perfumer(s). As previously described, treatment with a dryer sheet includes the use of a dryer sheet of the present invention (so called “Citrus and Light”) and a control dryer sheet (so called BOUNCE Outdoor Fresh). The results are reported herein as FIGS. 5 through 8.

The scale by which the expert perfumer evaluates the treatment and prevention of malodor on fabric is provided. The swatches are graded on a “Perfumer's Scale” of 0-100, where 0 is no detectable odor and 100 is a very strong odor. The targets in-between are a 10, which means “I think there is an odor,” 25, which means there is a “slight odor,” and 75, which refers to a strong odor. In between those targets, grades are given on increments of 5 points. The graders have been trained to distinguish for example a 60 from a 65 and on a relative scale can give grades in between the targets. A grade below 20 is considered unnoticeable by the average consumer. In other words, once a value below 20 is assessed, a consumer will generally interpret that the malodor is removed (vs. a malodor control). The data presented below is comprised of an average of two repetitions evaluated at least by two expert perfumers.

Citrus and Light (“C&L”) prevents malodor on fabric. The control is a swatch that has no dryer sheet treatment but is exposed to the same malodor as the treatment swatch. For smoke, the C&L decreased the final malodor grade an average of 42.5 points while maintaining a perfume grade of 57.5. The BOUNCE Outdoor Fresh (“ODF”) decreased only an average of 20.0 points and had a final perfume grade of 37.5. After 1 week, the samples are re-graded to evaluate any malodor prevention benefits. The C&L has the same drop (−40 points) versus the initial evaluation in malodor and perfume grade (55) remained the same. The ODF also has the same malodor decrease after 1 week (−25) versus the initial evaluation but its perfume grade is only a 35. Looking at the results from the ABO treatment, with the C&L, an average drop of 47.5 points in malodor grade is obtained while keeping the perfume grade at 57.5. The ODF decreased 40 points in its malodor grade and also has the perfume grade of 57.5. After 1 week, C&L has a 45 point decrease in malodor grade and a perfume grade of 60. The ODF has a decrease of 40 points in malodor but has a perfume grade of only 40 points. The results are reported herein as FIGS. 1 through 4.

C&L also treats malodor on fabric. Results were conducted and graded initially and again after a 1 week duration. For smoke, the C&L treatment caused the malodor grade to decrease 50 points, down to a final malodor grade of 10 (which is not consumer noticeable), while the perfume grade is at 60. The ODF treatment provides a decrease of 25 points, down to a final grade of 40, with a perfume grade of a 50. With ABO, C&L decreased the malodor grade 35 points and has a perfume grade of 55; ODF decreased the malodor grade 40 points and has a perfume grade of 65. After 1 week, the smoke grade for treatment with C&L remained at a 10 and the perfume grade is a 60. The smoke with ODF treatment after 1 week decreased 25 points and the perfume grade is at a 50. The 1 week data for ABO for C&L provides a decrease in malodor of 35 points and a final perfume grade of 60. For ODF, the malodor grade decreased 35 points and the perfume grade is a 50. The results are reported herein as FIGS. 5 through 8.

Extracting Free Perfume from Dryer-Added Article

One suitable way to measure and identify free perfume ingredients, including free reactive aldehyde moiety, can be done by includes the use of a Gas Chromatography/Mass Spectrometer system (GC/MS). For example, a 2-gram sample of the multiple use fabric conditioning composition is extracted with 5-mL dichloromethane (HPLC grade, Sigma-St. Louis Mo.). The extract is passed through a cation extraction resin to remove cationic surfactants. The supernatant is concentrated under gentle nitrogen to less than 1.0-mL, and reconstituted with dichloromethane to 1.0-ml. The concentrated extracts containing the free perfume composition is then analyzed using Agigent 5973 or 5972 GC/MS system. Free perfume ingredients are identified using perfume Mass Spectrometry library developed from the National Bureau of Standard and Technologies (NIST), 2002 Edition. The quantitation of the free perfume ingredients are accomplished using Flame ionization detector or selected ion monitoring methods (sycg as mass spectrometry) or combinations thereof, depending upon on resolution and level of interferences.

### Dryer Added Articles

Examples of dryer-added articles include those described in U.S. Pat. Nos. 3,989,63; 4,000,340; 4,055,248; 4,073,996; 4,022,938; 4,764,289; 4,808,086; 4,103,047; 4,014,432; 3,736,66; 3,701,202; 3,634,947; 3,633,538; 3,435,537; 6,604,297; and 6,787,510. See also International Patent Publication Nos.: WO 00/27991; and WO 00/65141.

In one embodiment, the article comprises a substrate. An example of a substrate includes a sheet. The sheet may be chosen from a paper, woven, or non-woven sheet, such as those described in U.S. Pat. Nos. 3,686,025; 5,470,492; 5,883,069; and 5,929,026. A substrate comprising a sponge is yet another example. An example of a non-woven dryer sheet is one from BBA Fiber Web. A commercially available example of an article comprising a substrate and fabric conditioning composition includes a dryer sheet such as those sold under the trademark BOUNCE®.

In a preferred embodiment, the dryer-added article further comprises a fabric conditioning composition. A “fabric conditioning composition” is herein defined as a composition that imparting one or more fabric care benefits such as softening, anti-static, color protection, etc., to fabrics. In one embodiment, the fabric care composition is disposed on the substrate (e.g., such as in a dryer sheet). In an alternative embodiment, the article of the present invention comprises a fabric condition composition without a substrate. Examples include dispensing the fabric conditioning composition, along with the perfume composition of the present invention, through a dispenser affixed to the outside surface of the dryer or inside surface of the dryer barrel or inside door, or integral to the dryer itself.

Other examples of dryer-added articles may include those described in U.S. Pat. Pub. Nos.: 2005/0192207; 2003/0192197; and 2003/0195130. In one embodiment, the article comprises a dryer-added, multiple use, article that is releasable attached to an inside surface of a dryer, preferably the dryer barrel, more preferably the fin of the dryer barrel. An example of a commercially available dryer bar is the X-STATIC in-dryer fabric softening bar from Ecolab, Inc.

### Fabric Conditioning Composition

The articles of the present invention may comprise a fabric conditioning composition. In turn, a fabric conditioning composition may comprise one or more fabric conditioning actives. Examples of fabric conditioning actives may include a fabric softening active and/or an antistatic active. The fabric care composition may comprise from at least about 0.001% to about 99.99%, alternatively about 1% to about 90%, alternatively from about 10% to about 50%, alternatively from about 15% to about 40% of one or more fabric conditioning actives by weight of the fabric care composition. In turn, the dryer-added article may comprise from at least about 0.001% to about 99.99%, alternatively about 1% to about 90%, alternatively from about 10% to about 50%, alternatively from about 15% to about 40% of a fabric conditioning composition by weight of the article.

The fabric softening actives can be one or a mixture of a quaternary ammonium compound, a tertiary amine and or its salts, an ethoxylated fatty material, a fatty acid, any fatty acid derivative, or a mixture thereof. Examples of fabric softening actives that may be useful in the articles are the compositions described in U.S. Pat. Nos. 4,103,047; 4,237,155; 3,686,025; 3,849,435; 4,073,996; and U.S. Pat. Publ. No. 2003/0195130, ¶¶14-17.

In one embodiment, the fabric softening active is chosen from at least one of the following: a quaternary ammonium compound as one described in U.S. Pat. No. 6,787,510, col. 4, line 12 et seq.; or a tertiary amine, as described in id. at col. 7, line 31 et seq.; or a nonionic softening active, id. at col. 8, line 63 et seq.; or a fatty acid, id. at col. 10, line 63 et seq.; or combinations thereof.

### Optional Components

The fabric conditioning composition may further comprise optional components used in textile treatment compositions including one or more of the following: soil release polymer, anti-oxidants, colorants, preservatives, optical brighteners, opacifiers, stabilizers such as guar gum and polyethylene glycol, anti-shrinkage agents, anti-wrinkle agents, soil release agents, fabric crisping agents, reductive agents, spotting agents, germicides, fungicides, anti-corrosion agents, antifoam agents, encapsulated perfumes (e.g., within a perfume microcapsule) and the like. In one embodiment, the fabric conditioning composition is free or substantially free of any one or more of the above-identified optional components.

Microcapsules are described in the following references: US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32,713; U.S. Pat. No. 4,234,627.

### Kits and Methods

One aspect of the invention provides for a kit comprising an article of the present invention, optionally comprising instructions, wherein preferably the instructions instruct the user to administer the article inside an automatic laundry dryer. In one embodiment, the instructions instruct the user on the malodor prevention or treatment benefits of the present invention.

Another aspect of the invention provides for a method of treating fabric comprising the step of administering an article of the present invention into an automatic laundry dryer.

### EXAMPLES

### Example 1

### Lab Scale Incorporation of a Free Perfume Comprising Reactive Aldehydes in a Dryer Sheet is Described

A fabric conditioning composition is melted at a temperature sufficient for the composition to attain a molten state. Next, a desired amount of free perfume ingredients, which includes reactive aldehydes of the present invention (in addition to any other fabric care ingredient(s) including but not limited to neat perfume(s), other perfume technology(s), &/or fabric care technologies) is added to the molten fabric conditioning composition and wherein the composition is mixed until a homogenous mixture is obtained. Thereafter, the homogenous mixture is poured onto a heated surface with a temperature that will allow the homogenous mixture to stay in a molten state. The temperature on the heated surface may remain at the desired, elevated level, by heating the surface with, for example, steam. Next, the molten, homogenous mixtures is impregnated or disposed onto a substrate, such as a non-woven sheet (such as in a BOUNCE dryer sheet substrate), at the desired weight amount. Finally, the substrate is removed from the surface to allow fabric conditioning composition mixture to achieve a solid state.

Examples of dryer sheet formulations suitable for use on non-woven dryer sheets include Examples A and B:

| | Example A | Example B | Example C |
|---|---|---|---|
| Ingredients | Wt. % | Wt. % | Wt. % |
| C Salt^{(a)} | 26.46 | 24.17 | 24.17 |
| KRA^{(b)} | 52.93 | 48.80 | 48.33 |
| Clay^{(c)} | 7.94 | 7.25 | 7.25 |
| Neat Perfume A^{(d)} | 2.91 | — | — |
| Neat Perfume B^{(d)} | — | 2.67 | 3.14 |
| GTB Base^{(e)} | 9.76 | 17.11 | 17.11 |
| Total | 100 | 100 | 100 |

^{(a)}Dimethyl Stearyl Amine & triple pressed Stearic Acid. Company: Peter Kramer
^{(b)}Di(tallow oxyethyl)hydroxyethylmethylammoniummethylsulfate. Company: Stepan
^{(c)}Calcium Monomorilonite. Company: Southern Clay
^{(d)}Fragrance. Company: Internally developed (Procter & Gamble) or externally such as Firmenich
^{(e)}Uncomplexed beta-cyclodextrin, with particle size of less than about 20 micrometer. Company: Wacker

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dryer-added fabric conditioning article comprising:
a) a non-woven sheet;
b) a fabric conditioning composition; and
c) at least 10 mg of a free perfume ingredient, wherein the ingredient comprises a reactive aldehyde functionality.

2. The article of claim 1, wherein the article comprises at least about 15 mg of the free perfume ingredient, wherein the ingredient comprises a reactive aldehyde functionality.

3. The article of claim 2, wherein the article comprises at least about 18 mg of the free perfume ingredient, wherein the ingredient comprises a reactive aldehyde functionality.

4. The article of claim 3, wherein the article comprises at least about 20 mg of the free perfume ingredient, wherein the ingredient comprises a reactive aldehyde functionality.

5. The article of claim 4, wherein the article comprises at least about 3 different perfume ingredients that comprise a reactive aldehyde moiety.

6. The article of claim 5, wherein the article comprises at least about 6 different perfume ingredients that comprise a reactive aldehyde moiety.

7. The article of claim 6, wherein the article comprises at least about 9 different perfume ingredients that comprise a reactive aldehyde moiety.

8. The use of a dryer-added article for the prevention of malodor on fabric comprising the step of adding the article of claim 1 into an automatic clothing dryer.

9. The article of claim 8, wherein the article comprises at least about 15 mg of the free perfume ingredient, wherein the ingredient comprises a reactive aldehyde functionality.

10. The article of claim 9, wherein the article comprises at least about 18 mg of the free perfume ingredient, wherein the ingredient comprises a reactive aldehyde functionality.

11. The article of claim 10, wherein the article comprises at least about 20 mg of the free perfume ingredient, wherein the ingredient comprises a reactive aldehyde functionality.

12. The article of claim 11, wherein the article comprises at least about 3 different perfume ingredients that comprise a reactive aldehyde moiety.

13. The article of claim 12, wherein the article comprises at least about 6 different perfume ingredients that comprise a reactive aldehyde moiety.

14. The article of claim 13, wherein the article comprises at least about 9 different perfume ingredients that comprise a reactive aldehyde moiety.

15. The use of a dryer-added article for the treatment of malodor on fabric comprising the step of adding the article of claim 1 into an automatic clothing dryer.

16. The article of claim 15, wherein the article comprises at least about 15 mg of the free perfume ingredient, wherein the ingredient comprises a reactive aldehyde functionality.

17. The article of claim 16, wherein the article comprises at least about 18 mg of the free perfume ingredient, wherein the ingredient comprises a reactive aldehyde functionality.

18. The article of claim 17, wherein the article comprises at least about 20 mg of the free perfume ingredient, wherein the ingredient comprises a reactive aldehyde functionality.

19. The article of claim 18, wherein the article comprises at least about 3 different perfume ingredients that comprise a reactive aldehyde moiety.

20. The article of claim 19, wherein the article comprises at least about 6 different perfume ingredients that comprise a reactive aldehyde moiety.
